(19) United States
(12) Patent Application Publication
(10) Pub. No.: US 2003/0058811 A1
(43) Pub. Date: Mar. 27, 2003

(54) Control of a multi-carrier power amplifier

(76) Inventor: William Shurvinton, Hampshire (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/168,562

(22) PCT Filed: Dec. 20, 2000
(86) PCT No.: PCT/EP00/13045

(30) Foreign Application Priority Data
Dec. 24, 1999 (GB) 9930711.8

(51) Int. Cl. H04B 7/212

(52) U.S. Cl. 370/321; 370/337

(57) ABSTRACT

A transmit power control system and method is provided which utilizes an efficient allocation of average output power of a multi-carrier power amplifier (MCPA), the average output power being a weighted average of the actual power over multiple time slots. Periodically, using the efficient allocation system and method, there will he short periods where the desired average output power will exceed the maximum tolerable power of the MCPA, P_{MCPA}. These short periods in which the desired output power will exceed P_{MCPA}, are handled by a system and method which produces a reduced margin between the total power per time slot and P_{MCPA}. This reduced margin allows the MCPA to serve a larger number of users per time slot than conventional MCPAs. Alternatively, the MCPA can serve the same number of users as a conventional MCPA, but with higher demands on output power for each user and/or more efficient use of the MCPA's resources.

This invention relates to a method and apparatus for dimensioning and controlling a multi-carrier power amplifier. It finds particular, but not exclusive use in a Base Transceiver Station (BTS) in a GSM based communication system.

Traditionally, GSM BTSs have employed single-carrier power amplification schemes. That is, a single amplifier chain was provided for each GSM carrier signal. Each GSM carrier signal comprises 8 time slots per frame, and is thus theoretically capable of supporting 8 conversations or data connections simultaneously.

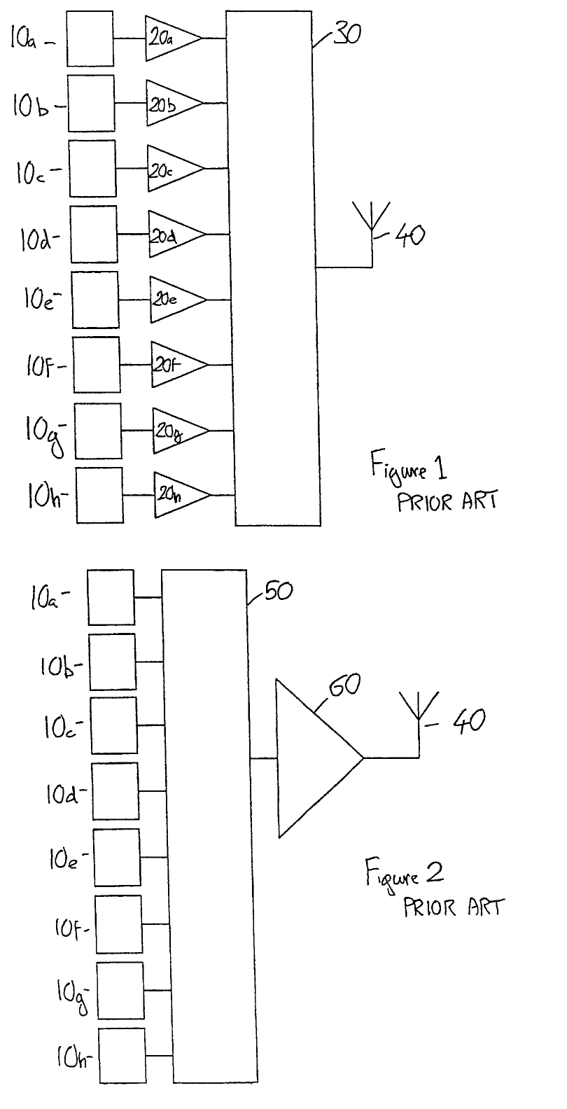

Typically, a BTS comprises several transceiver units, each one having a dedicated power amplifier (PA). FIG. 1 shows a BTS configuration according to the prior art. In this example, eight transceiver units (TRX) are provided 10a-10h. Each transceiver unit has an associated power amplifier (PA) 20a-20h. The Power Amplifier is responsible for boosting the output power of the TRX to a suitable level for transmission. However, the resultant signals from each of the PAs have to be combined in order to route them to a common transmission antenna. This requires the use of a high power combiner 30, which has the drawback that a considerable amount of the input power is dissipated in the combining process. Typically, 3.2 dB is dissipated in heat per 2-way combine in a hybrid combiner. As the output of eight TRXs need combining, there are 3 combining stages needed, resulting in a loss of nearly 10 dB, or 90% of the amplified signal. This places constraints on the BTS in the fields of power regulation and thermal design.

The configuration is actually more complicated due to the provisions made for the receive path from the antenna, but we are only concerned with the transmission path here.

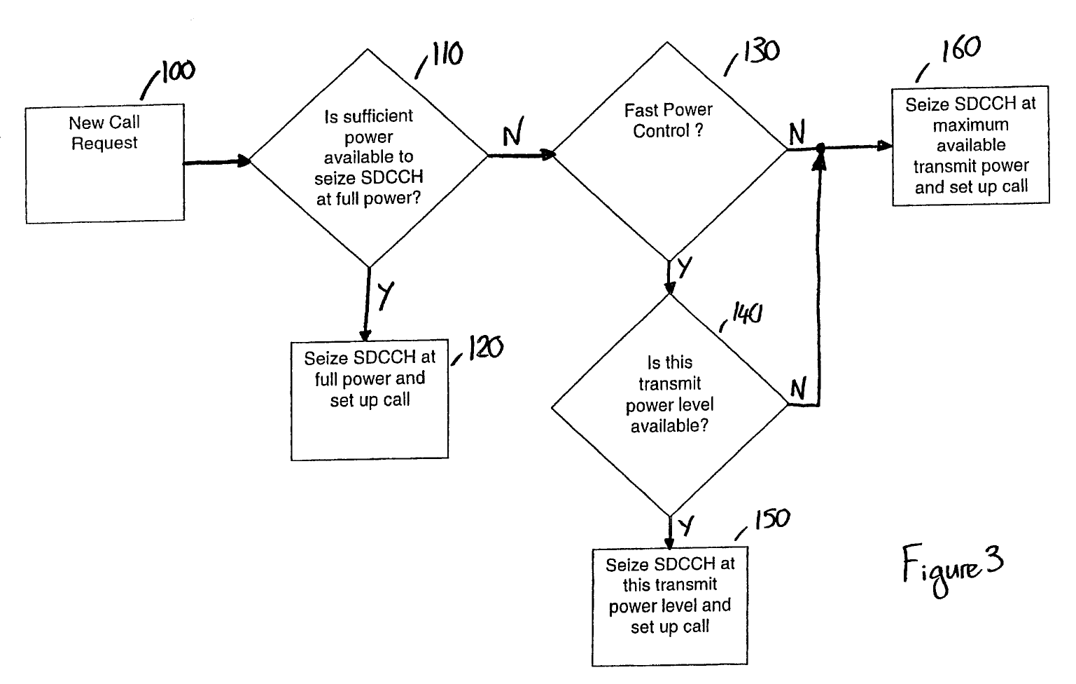

It is now possible to implement PAs which are capable of amplifying more than a single carrier signal. These are known as Multi-Carrier Power Amplifiers (MCPAs) or Multi-Carrier Linear Power Amplifiers (MCLPAs). Such a configuration is shown in FIG. 2. The TRXs 10a-10h are identical to those shown in FIG. 1, and each supports a single GSM carrier as before. The outputs from the TRXs are next combined in a low power combiner 50. The relative losses in this are still of the order of 10 dB in total, but as the input power to the combiner is considerably lower, the absolute power loss is much lower.

The output of the combiner 50 is next fed into the input of the MCPA 60. The MCPA is a wideband linear amplifier which, in this instance, is capable of amplifying the outputs of all eight TRXs simultaneously, before transmitting the signals via antenna 40.

One of the problems which has thus far held back deployment of MCPAs is the linearity which is required by the GSM specifications. GSM specification 05.05 Section 4.2.1, “Spectrum due to the modulation of wideband noise”, particularly sets the limits on the acceptable levels of noise products due to non-linearity effects in the PA. Only recently has it been possible to implement MCPAs which meet all the necessary criteria laid out in the GSM specifications.

Defining the transmit power output requirement for a single carrier PA (SCPA) is straightforward. The SCPA is capable of supporting up to eight simultaneous connections—one on each of the timeslots which make up a GSM frame. Each timeslot is processed in turn, and so the maximum output power required form the SCPA is equivalent to the maximum power called for in any one of the timeslots.

Defining the power output requirement for an MCPA can be more problematic. An assumption made in specifying the power output requirement for an MCPA is that if it is operating substantially linearly, then the total output power on a given timeslot is given by the sum of the individual powers of each carrier.

$${P}_{TOT} = {\sum }_{0}^{n} {P}_{n}$$

where n=number of GSM carriers being amplified, which is eight in the example cited in FIG. 2.

A simple means of defining the maximum power required would be to assume that each individual carrier operates at its maximum level, so that the total power output required is equal to the sum of each individual maximum power requirement, or

P_{TOT}=n·P_{MAX}

While this solution will produce an MCPA which will support each GSM carrier signal successfully under all conditions, it will be greatly over-specified, and will consume excessive amounts of energy. For example, linear PAs tend to be only 5-7% efficient, or to put it another way, 93-95% of the energy supplied is dissipated as heat. This inefficiency is due to the mode in which the amplifiers need to operate in order to meet the linearity specifications. The net result is that even if the transmitter is required to provide a relatively low amount of output RF power, or even no output at all, the amplifier remains biased in such a way that large amounts of heat have to be dissipated. For example, assuming that an MCPA supports eight 1W carriers, then it must be designed to dissipate between 100W and 150W of heat energy.

Not only do such requirements impose difficult design constraints on BTSs in terms of heat dissipation, but component failures increase with such increases in temperature, posing reliability problems. The added charges for electricity also become significant when applied across an entire cellular network.

According to a first aspect of the present invention, there is provided an amplifier for a communication system, wherein the amplifier is adapted to amplify a plurality of radio frequency input signals modulated onto individual carrier signals, and the total radio frequency output power of the amplifier is less than the sum of the maximum specified output powers of the individual carrier signals.

This advantageously allows the amplifier to be specified on the basis of predicted average loading, rather than the normal peak loading. This offers savings in components costs, electricity charges, and the consequential thermal design is simplified.

According to a second aspect of the present invention, there is provided a method of operating a Time Division Multiple Access (TDMA) communication system comprising a multi-carrier power amplifier, comprising the steps of: logging call activity on each timeslot of each carrier associated with the multi-carrier power amplifier; and logging total transmit power of the multi-carrier power amplifier for each timeslot, wherein a new call is assigned to a new timeslot on a given carrier such that total transmit power is substantially uniform across all timeslots.

Use of embodiments of the invention ensure that the total transmission power across all timeslots supported by the MCPA is balanced. This offers the advantage that if spare transmission power capacity is available, it is distributed across all the timeslots as evenly as possible. If a call corresponding to any given timeslot then requires more power, it is likely that such an increase can be accommodated from its present timeslot.

If the timeslots were allocated to calls on a random basis, it could well be that a first timeslot was operating at full power, and a second was carrying no calls at all. In this instance, any requirement for more transmission power for a call on the first timeslot requires substantial timeslot reallocation to occur.

Preferably, when a new call is set up, either due to a new call being initiated, or a handover from a neighbouring cell, then whichever timeslot has the lowest total transmit power at that moment is allocated that call. In the event that two timeslots are equal lowest, then the timeslot is allocated in temporal order.

Inevitably, calls are terminated and handed over to other cells, and this will unbalance the allocation of timeslots. Statistically, as many calls will be dropped as are set up, so this may not cause a problem in practice. However, to benefit from the invention, it is advantageous to periodically reassign timeslots to ensure that balance is maintained if periodic checking reveals this to be necessary.

This activity is under the control of the Base Station Controller (BSC) which provides call management functionality for the BTS.

In the case where the MCPA is dimensioned based on average power loads rather than peak loads, it is advantageous to reduce the number of occasions on which it is necessary to transmit at full power. One situation which normally requires a full power transmission is call setup. At call setup, a Traffic Channel is seized and used as a control channel (SDCCH) to inform the MS of various operational details. SDCCH is normally transmitted at full power regardless of how much power is actually needed.

Preferably, a power measurement based on the MS access request signal (RACH) can be taken using so-called fast power control, and this can be used to set a level for SDCCH which is less than maximum. If it transpires that the transmit power level chosen was too low for the MS to receive correctly, then the MS will attempt access again.

In the alternative, if fast power control is not viable for any reason, and it is not possible to seize a traffic channel at full power, then SDCCH can be transmitted at the maximum available transmit power. This is equivalent to the difference between the desired level, and the current transmit power level on a given timeslot.

If in spite of all these measures, no spare transmit power is available, then call set up for the new call will be refused, or handover will be denied, as appropriate.

For a better understanding of the present invention, and to understand how the same may be brought into effect, the invention will now be described, by way of example only, with reference to the appended drawings in which:

FIG. 1 shows some elements of the transmitter chain in a BTS utilising single carrier power amplifiers according to the prior art;

FIG. 2 shows some elements of the transmitter chain in a BTS utilising a multi-carrier power amplifier according to the prior art; and

FIG. 3 shows a flowchart according to an embodiment of the invention.

Empirical studies have shown that the vast majority of all GSM voice calls take place with the single carrier power amplifier (SCPA) of the BTS operating at 6 dB below its maximum output power. It is too simplistic to dimension the maximum transmit power of an MCPA based on this figure, as there will be occasions on which higher powers will be necessary, but the realisation that an MCPA may be dimensioned to take account of average power loads, rather than peak loads, offers the potential of lower overall power consumption.

Dimensioning according to average power loads is made possible because of the multi-carrier nature of the MCPA. If any one carrier is operating at a high power, then, on average, another one will be operating at a low power. This approach is not possible in the SCPA scenario. The SCPA must be able to provide maximum power if requested, and it cannot offset this power requirement against the power requirements of other SCPAs in the BTS.

In the case of a system employing SCPAs, to provide n carriers operating at up to the maximum specified power (0 dB), then the maximum transmit power obtainable from the system is n.Pₘₐₓ. To specify an MCPA to support the same n carriers, the simple approach would be to specify the MCPA to have a maximum transmit power of n.Pₘₐₓ also. As stated before, the invention is predicated on the realisation that it is highly unlikely that all carriers will be transmitting at full power on all timeslots. Hence, the MCPA is specified to have a maximum transmit power less than n.Pₘₐₓ.

An embodiment of the invention is an MCPA which is dimensioned on the basis of average transmission power load rather than maximum power load. The MCPA is designed to operate with a maximum transmit power of 6 dB below the specified maximum of the carriers that are input to the MCPA. This means that lower rated components may be used than those which are required in the MCPA specified on the maximum transmit power. Thermal design issues are also greatly simplified, and electricity costs are significantly reduced.

A level of 6 dB below the specified maximum corresponds to a signal having one quarter of the transmit power. Consequently, the total transmit power from the MCPA is equivalent to one quarter of the simply dimensioned MCPA or SCPA examples above. Further. such a dimensioned MCPA will have to dissipate 75% less heat than one specified on the crude basis described above.

This eases the problems involved in the thermal design of the BTS, and helps to reduce reliability problems related thereto.

The 6 dB figure quoted above results from studies carried out on a particular network, and it is to be expected that different networks will have different average figures depending on the quantity of data calls made, the geographical distribution of cell sites and average sizes of cell sites amongst other factors.

The other dimensioning techniques which may be used require an understanding of the various factors which affect the output power requirements of the MCPA, and particularly those factors which cause the MCPA to transmit at higher powers.

The main reason that an MCPA controls the output power of any given carrier is the desire to minimise interference with other carriers. Consequently, it will transmit at the minimum acceptable power consistent with maintaining a good connection with a mobile station (MS). The determination of the power is performed on the basis of measurements made by the MS and reported back to the BTS. In a situation where the MS is at the edge of a cell, or otherwise in an area of poor reception, the received signal at the MS will be low, and the MS will indicate to the BTS that the transmit power should be increased accordingly. If the transmitter is already operating at full power, then the call will be handed over to another cell if possible, or may be dropped.

As stated above, the vast majority of calls are found to require the PA to operate at least 6 dB below its maximum level. It is therefore desirable to discover which events require maximum transmit power, and to determine what, if anything, can be done to minimise their impact on the requirements for MCPA design.

As well as routine power control, which was referred to above, the transmit power of the MCPA can be affected by a number of different events.

Firstly, when a new call is set up, the MCPA routinely carries out a number of operations at full power (so-called set static level). When an MS requires a channel to be setup, it transmits a RACH (Random Access Channel) message to the BTS. Consequently, the BTS seizes a Traffic Channel (TCH) to use as a Standalone Dedicated Control Channel (SDCCH), which operates at full transmit power. This channel is used to transmit a string of messages to the MS in order to set up a communication channel and connect the MS to the network.

The SDCCH operates at full power because, at this stage in the current setup procedure, the transmit power requirements of the MS have not yet been established.

There may be occasions when it will not be possible to provide an SDCCH at full power, even though a traffic channel is available to be seized, because there is insufficient power available from the MCPA at that instant, due to the power requirements of other carriers on the same timeslot. This would never be a problem with an SCPA as it is always possible to operate a given channel at full power.

Power control is the process by which the transmit power requirements of an MS are established by taking readings of the received signal strength from the MS at the BTS. On the basis of these measurements, it is possible to deduce the likely transmit power which is needed to maintain a good connection. A problem with the RACH process is that traditionally it has been impossible to perform a signal measurement based on the RACH transmission alone. It has generally been the case that the measurement is taken over several transmission bursts. It is now possible, using fast power control, to make such a measurement based on the RACH transmission alone, and set the transmit power level of SDCCH accordingly. Use of this procedure reduces the situations where SDCCH needs to be transmitted at full power, and consequently reduces the overall transmit power requirements of the MCPA.

| | TS0 | | TS1 | | TS2 | | TS3 | | TS4 | | TS5 | | TS6 | | TS7 | |
|---|---|---|---|---|---|---|---|---|---|---|---|---|---|---|---|---|
| TRX0 | | | | | −2 | dB | −8 | dB | −4 | dB | | | −10 | dB | −4 | dB |
| TRX1 | | | −12 | dB | −12 | dB | | | −6 | dB | 0 | dB | | | −4 | dB |
| TRX2 | −4 | dB | −6 | dB | | | −2 | dB | −6 | dB | | | −12 | dB | | |
| TRX3 | −8 | dB | | | −8 | dB | | | | | | | −6 | dB | −8 | dB |
| TRX4 | | | −4 | db | | | −2 | dB | | | −6 | dB | | | | |
| TRX5 | −8 | dB | | | | | −8 | dB | | | | | | | −2 | dB |
| TRX6 | | | −6 | dB | | | | | −8 | dB | | | | | | |
| TRX7 | −2 | dB | | | 0 | dB | −8 | dB | | | | | −4 | dB | −10 | dB |

The table above shows an example of a database maintained by the system of the transmit power for each timeslot of each TRX which provides an input to the MCPA. If no entry is shown, then that timeslot on that TRX is not in use at that time. The total transmit power on a given timeslot is the sum of all the individual transmit powers from each TRX.

The Radio Resource Management (RRM) function of the Base Station Controller (BSC), which provides operational control functions for the BTS, continuously monitors the status of the timeslot/TRX assignments in the table, and allocates a given timeslot on a given TRX, when it is necessary to do so, on the basis of the current total transmit power requirement for any given timeslot. The assignment of a new call to a new timeslot is performed on the basis that it is desirable to ensure that the total transmit power for each individual timeslot should be kept as uniform as possible. i.e. there should be as little variation between the total transmit power for each individual timeslot as possible.

In particular, if the transmit power on a given timeslot can be kept at a level of 6 dB below maximum, which is the empirical level at which the majority of GSM calls are made, then that provides sufficient scope for sudden unexpected higher power transmissions to be accommodated.

To achieve this goal, the timeslot assignments as shown in tabular form above are routinely monitored, and when a new call is set up, due to either a RACH request, or a handover from another cell, then the timeslot with the current lowest total transmit power on a given TRX is assigned to the new call. This ensures that as calls are set up and dropped, the variation in total transmit power from timeslot to timeslot is minimised.

As calls terminate, or are handed over to neighbouring cells, the power balance between the timeslots may be disrupted. In order to ensure that the balance is maintained, the BSC can re-allocate timeslots by informing an associated mobile station MS that its allocated timeslot has changed. The instruction to the MS is issued on the Slow Associated Control Channel (SACCH). This will be undetectable by a user of the MS.

In summary, FIG. 3 shows an embodiment of the present invention. A new call is attempted at 100. A check 110 is made to determine whether there is sufficient transmit power available on any given timeslot in order to seize SDCCH at full power. If sufficient power is available, then SDCCH is seized at full power and the call set up procedure continues 120.

Is insufficient power is available, then a fast power control measurement is attempted 130. If this process produces a result, a check is made to determine whether the required transmit power level is available 140.

If this level is available, then SDCCH is seized at that power, and the call set up procedure continues 150.

If either fast power control is not possible, or if it is possible but the required transmit power is not available, then SDCCH is seized at the maximum available transmit power 160. This power is equivalent to the difference between the specified maximum transmit power and the current transmit power.

In parallel with the processes shown in FIG. 3, the system continuously monitors all call activity and timeslot assignments, and re-allocates timeslot assignments as necessary to maintain the transmit power balance across all timeslots.

The present invention includes any novel feature or combination of features disclosed herein either explicitly or any generalisation thereof irrespective of whether or not it relates to the claimed invention or mitigates any or all of the problems addressed.

1. An amplifier for a communication system, wherein the amplifier is adapted to amplify a plurality of radio frequency input signals modulated onto individual carrier signals, and the total radio frequency output power of the amplifier is less than the sum of the maximum specified output powers of the individual carrier signals.

2. An amplifier as claimed in claim 1 wherein the total radio frequency output power is determined on the basis of an average loading of the amplifier.

3. An amplifier as claimed in claim 2 wherein the amplifier is arranged to operate according to a Time Division Multiple Access communication standard.

4. An amplifier according to claim 3 wherein total transmit power for each timeslot is arranged such that total transmit power is substantially constant across all timeslots.

5. A Base Transceiver Station comprising an amplifier according to any one of the previous claims.

6. A communication system incorporating the Base Transceiver Station of claim 5.

7 A method of operating a Time Division Multiple Access (TDMA) communication system comprising a multi-carrier power amplifier, comprising the steps of:
logging call activity on each timeslot of each carrier associated with the multi-carrier power amplifier; and
logging total transmit power of the multi-carrier power amplifier for each timeslot, wherein a new call is assigned to a new timeslot on a given carrier such that total transmit power is substantially uniform across all timeslots.

8. A method as claimed in claim 7, wherein the new call is assigned to the timeslot having the lowest total transmit power.

9. A method as claimed in claim 7 or 8, wherein current timeslot assignments are altered in order to achieve substantial uniformity across all timeslots.

10. A method as claimed in any one of claims 7 to 9, wherein set up of a new call is performed at a reduced transmit power level.

11. A method as claimed in claim 10, wherein the reduced transmit power level is determined on the basis of a power control measurement of the access request signal from a mobile station.

12. A method as claimed in claim 10, wherein the reduced transmit power level is equivalent to the difference between the maximum transmit power level, and the current transmit power level.

13. A method as claimed in any one of claims 7 to 12, wherein set up of a new call is refused in the event that insufficient transmit power is available at any given time.
